(19) United States
(12) Patent Application Publication
(10) Pub. No.: US 2015/0116063 A1
(43) Pub. Date: Apr. 30, 2015

(54) ELECTROMAGNETIC DEVICE AND CONDUCTIVE STRUCTURE THEREOF

(71) Applicant: Delta Electronics (Shanghai) Co., Ltd., Shanghai (CN)

(72) Inventors: Teng LIU, Shanghai (CN); Ai-Xing TONG, Shanghai (CN)

(21) Appl. No.: 14/447,640

(22) Filed: Jul. 31, 2014

(30) Foreign Application Priority Data
Oct. 29, 2013 (CN) 201310522211.7

(51) Int. Cl. H01F 7/20

(52) U.S. Cl. CPC H01F 7/20; H01F 2007/062
USPC 335/299

(57) ABSTRACT

A conductive structure for an electromagnetic device includes a conductive sheet and a plurality of protrusions. The conductive sheet includes two electrical connection terminals. The protrusions are arranged between the electrical connection terminals. The protrusions include a support. The support is connected to the conductive sheet. Adjacent two of the protrusions define a first heat dissipation passage.

### RELATED APPLICATIONS

This application claims priority to China Application Serial Number 201310522211.7, filed Oct. 29, 2013, which is herein incorporated by reference.

### BACKGROUND

1. Technical Field

Embodiments of the present invention relate to an electromagnetic device. More particularly, embodiments of the present invention relate to an electromagnetic device and the conductive structure thereof.

2. Description of Related Art

Electromagnetic device is one of the key components in the electricity system. For example, the electromagnetic device, such as the electric reactor and the transformer, has been widely applied in various electricity systems. However, the electromagnetic device inevitably produces heat energy during operation. In order to make the electromagnetic device work normally without being affected by the heat energy, various heat dissipation techniques are employed.

The heat dissipation technology generally includes the liquid cooling and the air cooling. In the liquid cooling, a liquid cooling plate is positioned on a particular position in the electromagnetic device. The liquid flows through the liquid cooling plate, absorbing and taking away the heat, so as to achieve heat dissipation. In addition to the liquid cooling plate, the accessories, such as the circulation fluid tank, the circulation pump, the heat exchanger and the pipes, are required as well, which increase the cost. Moreover, lots of joints exist in the circulation path of the fluid, and therefore, the fluid may leak and damage the electromagnetic device.

In the air cooling, some insulation pillars are disposed between the magnetic core and the winding, and some insulation pillars are disposed between the layers of the winding, so as to define airflow passages. The cool air flows into the airflow passage, and then, it absorbs heat and flows out of the airflow passage, so as to achieve heat dissipation. However, because the heat dissipation ability of the air cooling is in positive correlation with the contact area where the winding contacts with the airflow, the contact area is determined by the surface area of the winding. As a result, due to the limit of the surface area of the winding, the heat ability of the air cooling is limited, which is difficult to satisfy the requirement of the heat dissipation ability of the high power electromagnetic device.

### SUMMARY

One aspect of the present disclosure is to improve the heat dissipation ability of the electromagnetic device.

In accordance with one embodiment of the present invention, a conductive structure for an electromagnetic device includes a conductive sheet and a plurality of protrusions. The conductive sheet has two electrical connection terminals. The protrusions are arranged between the electrical connection terminals. The protrusions include a support which connects with the conductive sheet. Two of the protrusions adjacent to each other define a first heat dissipation passage.

In accordance with another embodiment of the present disclosure, an electromagnetic device includes a winding. The winding includes at least one conductive structure. The conductive structure includes a conductive sheet and a plurality of protrusions. The conductive sheet has two electrical connection terminals. The protrusions are arranged between the electrical connection terminals. The protrusions include a support connected to the conductive sheet. Two of the protrusions adjacent to each other define a first heat dissipation passage.

In accordance with another embodiment of the present disclosure, an electromagnetic device includes an insulation structure and two conductive layers. The insulation structure is sandwiched between two conductive layers. At least one of the conductive layers includes a conductive structure. The conductive structure includes a conductive sheet and a plurality of protrusions. The conductive sheet has two electrical connection terminals. The protrusions are arranged between the electrical connection terminals. The protrusions include a support connected to the conductive sheet. Two of the protrusions adjacent to each other define a first heat dissipation passage.

In the foregoing conductive structure, protrusions are disposed on the conductive sheet. As such, the contacting surface that the conductive structure contacts with the airflow may not be planar and may be uneven, which may effectively improve the heat dissipation ability.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of the electromagnetic device in accordance with one embodiment of the present disclosure;

FIG. 2 is a top view of the electromagnetic device in FIG. 1;

FIG. 3 is a fragmentary perspective view of the conductive structure in FIG. 1;

FIG. 4 is a fragmentary perspective view of the conductive structure in accordance with another embodiment of the present disclosure;

FIG. 5 is a fragmentary perspective view of the conductive structure in accordance with another embodiment of the present disclosure;

FIG. 6 is a fragmentary perspective view of the conductive structure in accordance with another embodiment of the present disclosure;

FIG. 7 is a fragmentary perspective view of the conductive structure in accordance with another embodiment of the present disclosure;

FIG. 8 is a fragmentary perspective view of the conductive structure in accordance with another embodiment of the present disclosure;

FIG. 9 is a fragmentary perspective view of the conductive structure in accordance with another embodiment of the present disclosure;

FIG. 10 is a top view of the electromagnetic device in accordance with another embodiment of the present disclosure;

FIG. 11 is a top view of the electromagnetic device in accordance with another embodiment of the present invention;

FIG. 12 is a top view of the electromagnetic device in accordance with another embodiment of the present disclosure;

FIG. 13 is a perspective view of the electromagnetic device in accordance with another embodiment of the present disclosure; and

FIG. 14 is a perspective view of the electromagnetic device in accordance with another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. However, the details disclosed below may not be all essential or necessary, and are not for limitation of present invention.

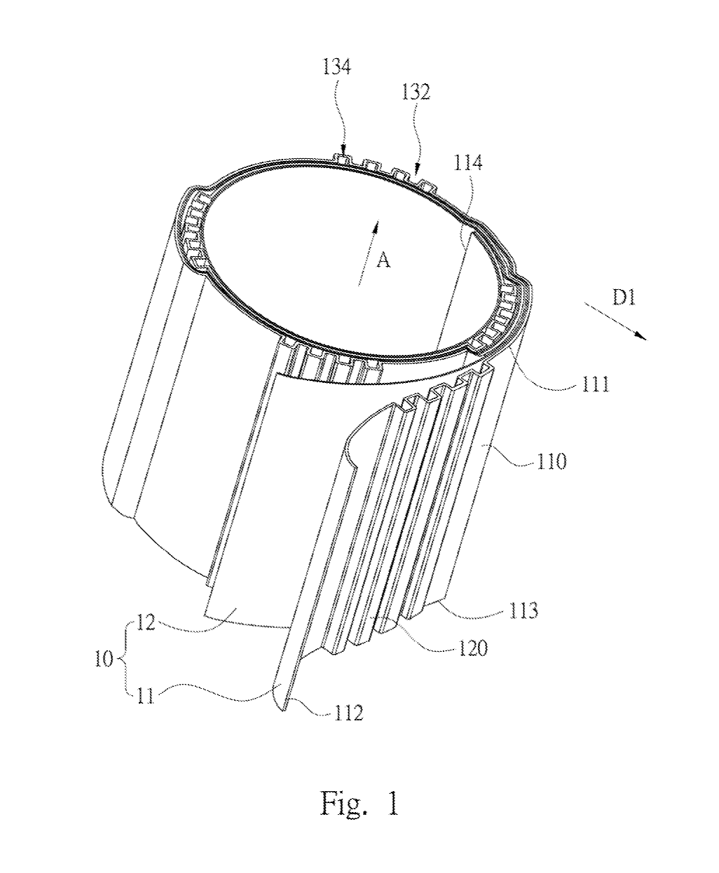

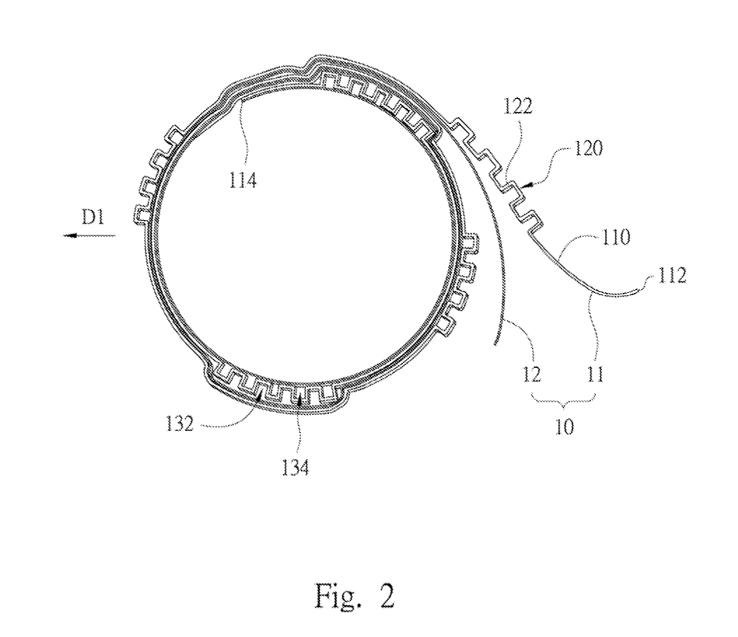

FIG. 1 is a perspective view of the electromagnetic device in accordance with one embodiment of the present disclosure. FIG. 2 is a top view of the electromagnetic device in FIG. 1. As shown in FIGS. 1 and 2, the electromagnetic device includes a winding 10. The winding 10 includes a conductive structure 11. The conductive structure 11 includes a conductive sheet 110 and a plurality of protrusions 120. The conductive sheet 110 has two electrical connection terminals 112 and 114 for connecting external electric devices. The protrusions 120 are disposed on the conductive sheet 110. Each of protrusions 120 includes a support 122. The supports 122 are connected to the conductive sheet 110. The protrusions 120 and the conductive sheet 110 are conductors. The protrusions 120 are arranged between the electrical connection terminals 112 and 114. As shown in FIG. 2, two of the protrusions 120 adjacent to each other define a first heat dissipation passage 132. When the conductive structure 11 is conducted, the current flows through the conductive sheet 110 and the protrusions 120, and makes the conductive sheet 110 and the protrusions 120 generate heat. The airflow blown by heat dissipation fan (not shown) at least passes through the first heat dissipation passage 132, so as to transfer the heat generated from the conductive sheet 110 and the protrusions 120, thereby achieving heat dissipation. Further, because the protrusions 120 are protruded on the conductive sheet 110, the contacting surface that the conductive structure 11 contacts with the airflow is not planar and is uneven, which may effectively improve the heat dissipation ability.

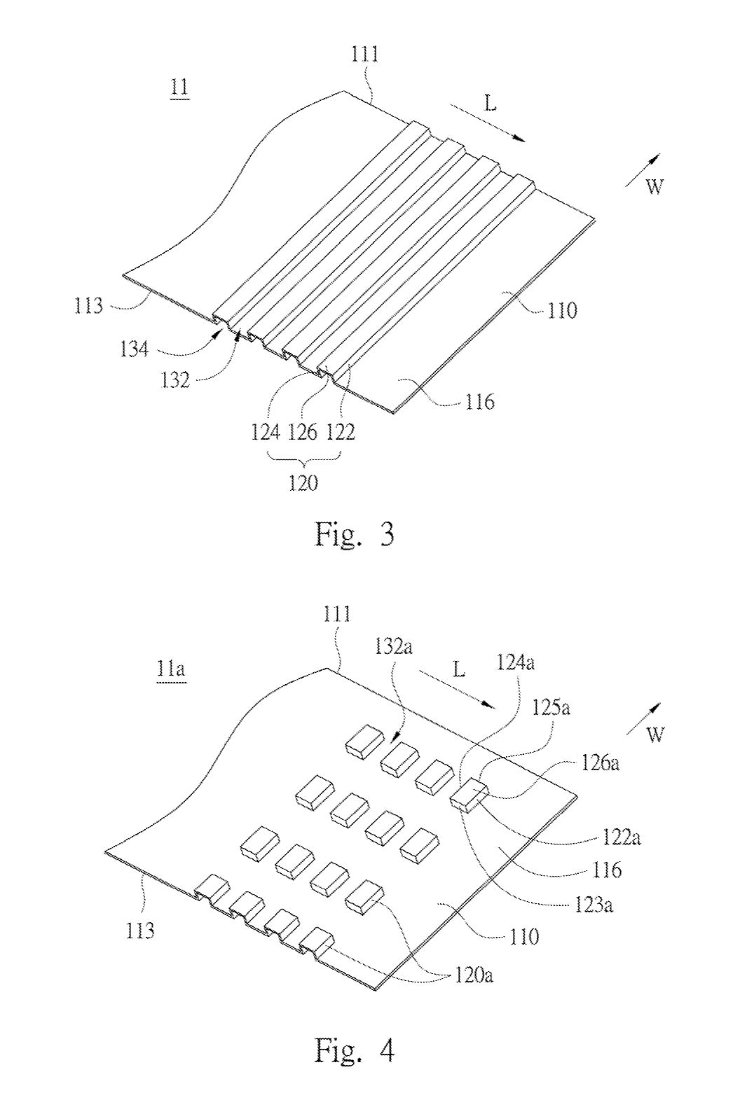

As shown in FIG. 1, the conductive sheet 110 includes a top long side 111 and a bottom long side 113. The top long side 111 and the bottom long side 113 connect with and are adjoined between the electrical connection terminals 112 and 114 (See FIG. 1). FIG. 3 is a fragmentary perspective view of the conductive structure 11 in FIG. 1. As shown in FIG. 3, in this embodiment, the conductive sheet 110 has a lengthwise direction L and a widthwise direction W perpendicular to the lengthwise direction L. The lengthwise direction L extends across the electrical connection terminals 112 and 114 (See FIG. 1 or 2). The widthwise direction W extends across the top long side 111 and the bottom long side 113. The protrusions 120 are arranged along the lengthwise direction L of the conductive structure 11, and they are arranged at intervals. In such a configuration, the first heat dissipation passage 132 between two of the protrusions 120 adjacent to each other can extend along the widthwise direction W of the conductive sheet 110, such that the airflow can flow along the widthwise direction W of the conductive sheet 110. Further, as shown in FIG. 1, the winding 10 has an axial direction A. After the conductive structure 11 is wound as a cylinder, the widthwise direction W of the conductive sheet 110 (See FIG. 3) is the axial direction A of the winding 10, and the airflow can flow through the first heat dissipation passage 132 along the axial direction A of the winding 10, so as to maybe facilitate heat dissipation. In this embodiment, the lengthwise direction L is the direction parallel to the longest side of the conductive sheet 110, and the widthwise direction W is the direction parallel to the side that is only shorter than the longest side of the conductive sheet 110.

In some embodiments, as shown in FIG. 3, each of the protrusions 120 has a second heat dissipation passage 134 therein. The second heat dissipation passage 134 and the first heat dissipation passage 132 are arranged alternately. In particular, each of the protrusions 120 includes two opposite supports 122, 124 and a top plate 126. The supports 122 and 124 are connected to the conductive sheet 110. The top plate 126 is connected to the sides of the supports 122 and 124 that are farthest from the conductive sheet 110. A second heat dissipation passage 134 is formed between the supports 122 and 124 of one of the protrusions 120. In other words, the second heat dissipation passage 134 is positioned within the protrusion 120 and between the supports 122 and 124. In detail, at least one of the protrusions 120 is a stick that connects the top long side 111 and the bottom long side 113, is a hollow structure having two openings on opposite ends thereof, and has a second heat dissipation passage 134 therein. The supports 122 and 124 of the protrusion 120 being a stick are flat.

The supports 122 and 124 are arranged along the lengthwise direction L of the conductive sheet 110, and therefore, the second heat dissipation passage 134 between the supports 122 and 124 can extend along the widthwise direction W of the conductive sheet 110. As such, the airflow can flow in the second heat dissipation passage 134 along the widthwise direction W of the conductive sheet 110. As a result, the airflow not only contacts with the outer surface of the protrusion 120, but also contacts with the inner surface of the protrusion 120, so as to maybe increase the contacting surface and improve the heat dissipation ability.

In some embodiments, as shown in FIG. 3, the first heat dissipation passage 132 and the second heat dissipation passage 134 are separated by the support 122 or 124. In other words, the first heat dissipation passage 132 and the second heat dissipation passage 134 are respectively positioned on opposite sides of the support 122 or 124. Therefore, the extension directions of the first heat dissipation passage 132 and the second heat dissipation passage 134 are the same as the extension directions of the supports 122 and 124. In other words, the first heat dissipation passage 132 and the second heat dissipation passage 134 extend along the widthwise direction W of the conductive sheet 110.

In some embodiments, as shown in FIG. 3, the conductive sheet 110 has a connecting surface 116. The protrusions 120 are connected to the connecting surface 116. As shown in FIG. 3, the protrusion 120 has a cross-sectional pattern defined along a direction perpendicular to the connecting surface 116, and the cross-sectional pattern is inverted-U shaped. In other embodiments, the cross-sectional pattern of the protrusion 120 defined along the direction perpendicular to the connecting surface 116 can be, but is not limited to be, inverted-V shaped, trapezoidal or arc-shaped.

In some embodiments, as shown in FIG. 3, all of the protrusions 120 have the same cross-sectional patterns defined along the direction perpendicular to the connecting surface 116. In other embodiments, at least two of the protrusions 120 have different cross-sectional patterns defined along a direction perpendicular to the connecting surface 116. For example, some protrusions 120 have inverted-U shaped cross-sectional pattern defined along the direction perpendicular to the connecting surface 116, and some protrusions 120 have arc-shaped cross-sectional pattern defined along the direction perpendicular to the connecting surface 116.

In some embodiments, as shown in FIG. 3, the protrusions 120 and the conductive sheet 110 are integrally formed. For example, the conductive sheet 110 and the protrusions 120 are formed by the same conductive piece, and the protrusions 120 are formed by punching the conductive piece. In some embodiments, the material of the conductive sheet 110 and the protrusions 120 includes, but is not limited to include, copper, aluminum, copper alloy or aluminum alloy.

In some embodiments, as shown in FIG. 2, the protrusions 120 are arranged on a partial area of the conductive sheet 110. In other words, the protrusions 120 do not cover the whole conductive sheet 110. Namely, other area of the conductive sheet 110 does not have the protrusions 120 thereon. In other embodiments, the protrusions 120 can cover the whole conductive sheet 110.

In some embodiments, as shown in FIG. 2, the protrusions 120 are arranged equidistantly. In other words, the distance between any two of the protrusions 120 adjacent to each other is constant, so as to make the widths of different first heat dissipation passages 132 equal. In other embodiments, the protrusions 120 can be arranged non-equidistantly, so as to make the widths of different first heat dissipation passages 132 unequal.

In some embodiments, as shown in FIG. 1, winding 10 includes an insulation structure 12. The insulation structure 12 contacts with the conductive structure 11. The conductive structure 11 and the insulation structure 12 may be cooperatively wound as a cylinder. The insulation structure 12 may be coaxial with the conductive structure 11. In such a configuration, when the winding 10 is wound outwardly along the radial direction D1 to be a multi-layered structure, the conductive structure 11 and the insulation structure 12 can be arranged alternately, and therefore, the insulation structure 12 can separate the portions of the conductive structure 11 that are positioned on different layers, so as to maybe prevent the portions of the conductive structure 11 on different layers from electrically being connected to each other.

FIG. 4 is a fragmentary perspective view of the conductive structure 11a in accordance with another embodiment of the present disclosure. As shown in FIG. 4, the main difference between the conductive structure 11a and the foregoing conductive structure 11 is that: at least two of the protrusions 120a are spatially separated from each other along the widthwise direction W. These protrusions 120a are arranged along a direction that is not parallel to the lengthwise direction L of the conductive sheet 110. In particular, the protrusions 120a may be arranged in a row along the widthwise direction W of the conductive sheet 110 and the protrusions 120a in the same row are spatially separated from each other along the widthwise direction W. The first heat dissipation passage 132a is positioned between two protrusions 120a adjacent to each other. For example, two protrusions 120a adjacent to each other along the lengthwise direction L are aligned along the lengthwise direction L, so as to form the first heat dissipation passage 132a therebetween.

It is understood that the “objects in the same row” in this context are the objects arranged along the widthwise direction W. For example, the protrusions 120a in the same row are the protrusions 120a arranged along the widthwise direction W.

In some embodiments, as shown in FIG. 4, the protrusions 120a in the same row are aligned along the widthwise direction W of the conductive sheet 110. In particular, each of the protrusions 120a includes two opposite supports 122a and 124a. The supports 122a and 124a can be two parallel walls, and they are parallel to the widthwise direction W of the conductive sheet 110. The supports 122a of two adjacent protrusions 120a in the same row are coplanar. Similarly, the supports 124a of two adjacent protrusions 120a in the same row are coplanar. As such, two adjacent protrusions 120a in the same row can be aligned with each other along the widthwise direction W of the conductive sheet 110.

In some embodiments, as shown in FIG. 4, each of the protrusions 120a has a rectangular cross-sectional pattern. In particular, each of the protrusions 120a includes another two opposite supports 123a, 125a and a top plate 126a. The supports 123a and 125a are two parallel walls, and they are parallel to the lengthwise direction L of the conductive sheet 110. The supports 122a, 123a, 124a and 125a are connected sequentially, and they are connected to the connecting surface 116 of the conductive sheet 110. The top plate 126a is connected to sides of the supports 122a, 123a, 124a and 125a farthest from the connecting surface 116, so as to form the rectangular cross-sectional pattern. In other embodiments, one of the protrusions 120a can have, but is not limited to have, a diamond-shaped cross-sectional pattern, a circular cross-sectional pattern, an elliptic cross-sectional pattern or a triangular cross-sectional pattern.

Other features of the conductive structure 11a are similar to the foregoing description relating to the conductive structure 11, and are not described repeatedly.

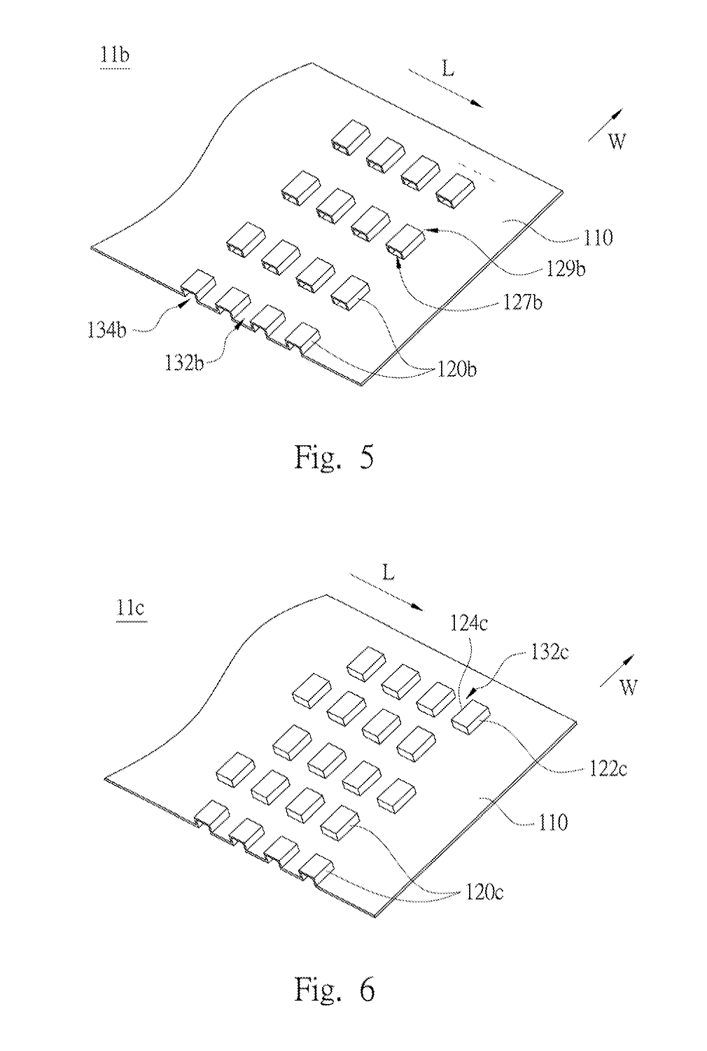

FIG. 5 is a fragmentary perspective view of the conductive structure 11b in accordance with another embodiment of the present disclosure. As shown in FIG. 5, the main difference between the conductive structure 11b and the conductive structure 11a is that: at least one of the protrusions 120b is a hollow structure having two openings 127b and 129b on opposite ends thereof. In other words, the openings 127b and 129b are spatially connected to each other and the widthwise direction W of the conductive sheet 110 extends across the openings 127b and 129b. As such, the protrusions 120b in the same row can form the second heat dissipation passage 134b via the openings 127b and 129b, which allows the airflow to flow therethrough. The second heat dissipation passage 134b and the first heat dissipation passage 132b are arranged alternately. In other words, the airflow not only contacts with the outer surface of the protrusion 120b, but also contacts with the inner surface of the protrusion 120b, so as to maybe increase the contacting surface and improve the heat dissipation ability.

Other features of the conductive structure 11b are similar to the description relating to the conductive structure 11a, and are not described repeatedly.

FIG. 6 is a fragmentary perspective view of the conductive structure 11c in accordance with another embodiment of the present disclosure. As shown in FIG. 6, the main difference between the conductive structure 11c and the conductive structure 11a is that: adjacent two of the protrusions 120c in the same row are misaligned along the widthwise direction W. In particular, each of the protrusions 120c has supports 122c and 124c parallel to the widthwise direction W of the conductive sheet 110. The supports 122c of adjacent two of the protrusions 120c in the same row are not coplanar. Similarly, the supports 124c of adjacent two of the protrusions 120c in the same row are not coplanar. As such, adjacent two of the protrusions 120c in the same row can be misaligned along the widthwise direction W.

Through the foregoing misalignment design, the airflow in the first heat dissipation passage 132c tends to form turbulence, which may increase the heat transfer coefficient, thereby maybe improving the heat dissipation ability.

Other features of the conductive structure 11c are similar to the foregoing description relating to the conductive structure 11a, and are not described repeatedly.

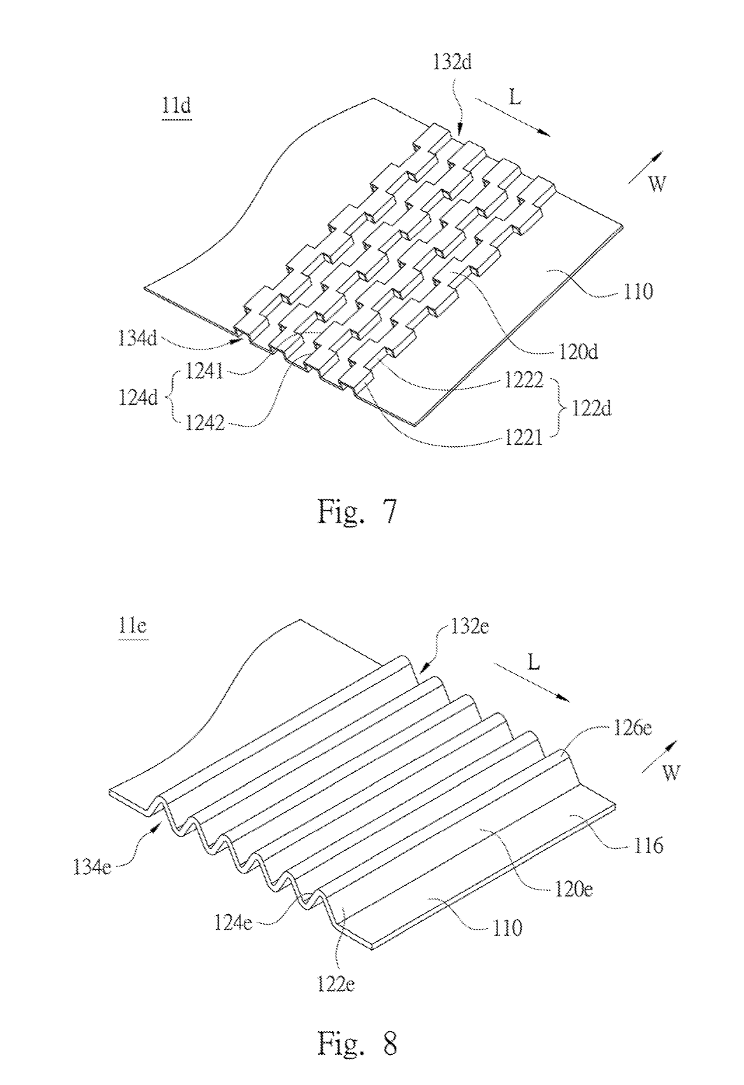

FIG. 7 is a fragmentary perspective view of the conductive structure 11d in accordance with another embodiment of the present disclosure. As shown in FIG. 7, the main difference between the conductive structure 11d and the conductive structure 11 (See FIG. 3) is that: the supports 122d and 124d of the protrusion 120d being the stick are uneven. For example, the support 122d includes a plurality of protruded surfaces 1221 and a plurality of concave surfaces 1222. The protruded surfaces 1221 and the concave surfaces 1222 are arranged alternately. The protruded surfaces 1221 and the concave surfaces 1222 are parallel to the widthwise direction W of the conductive sheet 110, and the protruded surface 1221 and the concave surface 1222 are not coplanar. As such, the support 122d can be uneven. Similarly, the support 124d includes a plurality of protruded surfaces 1241 and a plurality of concave surfaces 1242. The protruded surfaces 1241 and the concave surfaces 1242 are arranged alternately. The protruded surfaces 1241 and the concave surfaces 1242 are parallel to the widthwise direction W of the conductive sheet 110, and the protruded surface 1241 and the concave surface 1242 are not coplanar. As such, the support 124d can be uneven.

Through the uneven design to the supports 122d and 124d, the airflow in the first heat dissipation passage 132d and the second heat dissipation passage 134d tends to form turbulence, which may increase the heat transfer coefficient, thereby maybe improving the heat dissipation ability.

In some embodiments, in each of the protrusions 120d, the protruded surface 1221 of the support 122d and the concave 1242 of the support 124d are aligned along the lengthwise direction L of the conductive sheet 110. Similarly, the concave surface 1222 of the support 122d and the protruded surface 1241 of the support 124d are aligned along the lengthwise direction L of the conductive sheet 110, so as to make the first heat dissipation passage 132d and the second heat dissipation passage 134d meandering, thereby maybe improving the turbulent airflow.

Other features of the conductive structure 11d are similar to the foregoing description relating to the conductive structure 11 (See FIG. 3), and are not described repeatedly.

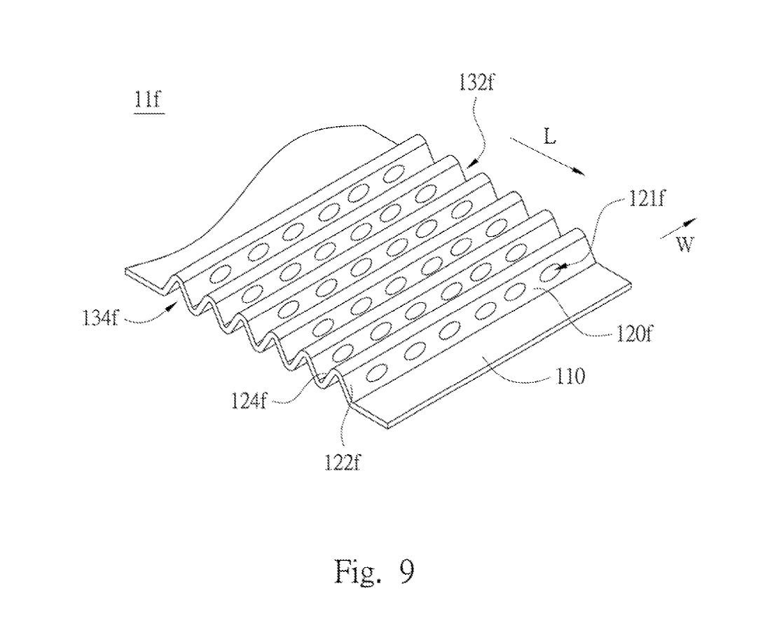

FIG. 8 is a fragmentary perspective view of the conductive structure 11e in accordance with another embodiment of the present disclosure. As shown in FIG. 8, the main difference between the conductive structure 11e and the conductive structure 11 (See FIG. 3) is that: the cross-sectional pattern of the protrusion 120e defined along the direction perpendicular to the connecting surface 116 is inverted-V shaped. In particular, the supports 122e and 124e of the protrusion 120e are obliquely connected to the connecting surface 116 of the conductive sheet 110, and the top plate 126e is arc-shaped and is connected to the sides of the supports 122e and 124e farthest from the conductive sheet 110. The cross-sectional pattern of the supports 122e, 124e and top plate 126e defined along the direction perpendicular to the connecting surface 116 may be inverted-V shaped. In such a configuration. The first heat dissipation passage 132e and the second heat dissipation passage 134e can be formed in the shape different from the first heat dissipation passage 132 and the second heat dissipation passage 134 as shown in FIG. 3.

Other features of the conductive structure 11e are similar to the foregoing description relating to the conductive structure 11 (See FIG. 3), and are not described repeatedly.

FIG. 9 is a fragmentary perspective view of the conductive structure 11f in accordance with another embodiment of the present disclosure. As shown in FIG. 9, the main difference between the conductive structure 11f and the conductive structure 11e is that: the support 122f or 124f of the protrusion 120f being the stick has at least one through hole 121f. The through hole 121f connects the first heat dissipation passage 132f and the second heat dissipation passage 134f. As such, the airflow in the first heat dissipation passage 132f and the airflow in the second heat dissipation passage 134f can be mixed with each other, so as to maybe facilitate the turbulent flow, thereby maybe improving the heat dissipation ability.

In some embodiments, the supports 122f and 124f can have through holes 121f, so as to maybe facilitate to mix the airflow, thereby maybe improving the heat dissipation ability.

In this embodiment, the protrusion 120f being the stick is taken as an example, but in other embodiments, as shown in FIG. 4, the supports 122a and 124a of the protrusion 120a can also have through holes 121f, so as to maybe facilitate the turbulent flow, thereby maybe improving the heat dissipation ability.

Other features of the conductive structure 11f are similar to the foregoing description relating to the conductive structure 11e, and are not described repeatedly.

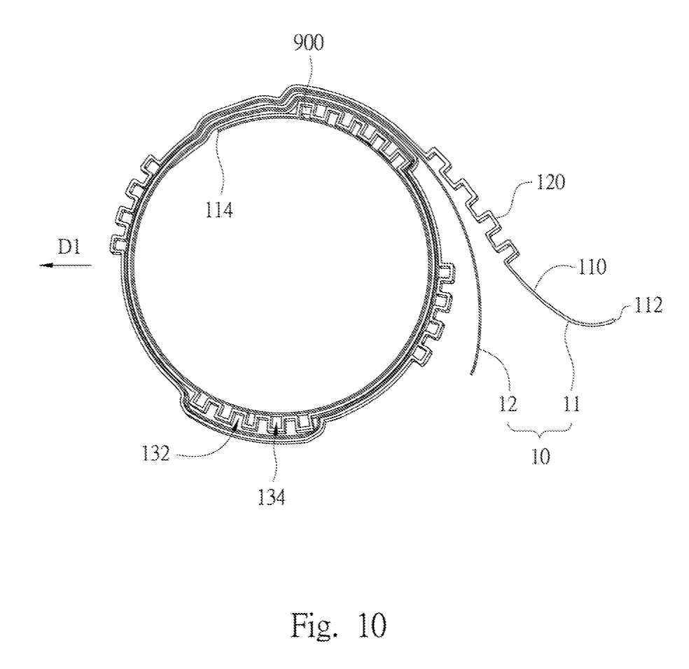

FIG. 10 is a top view of the electromagnetic device in accordance with another embodiment of the present disclosure. As shown in FIG. 10, the main difference between this embodiment and FIG. 2 is that: the electromagnetic device further includes at least one block 900, one of the protrusions 120 is a hollow structure, and the block 900 is arranged in the protrusion 120 being the hollow structure, so as to maybe prevent deformation of the protrusion 120 when it is exerted by an external force. In some embodiments, only some protrusions 120 have blocks 900 therein, and other protrusions 120 do not have blocks 900 therein, so as to maybe prevent from affecting the airflow and reducing the heat dissipation ability.

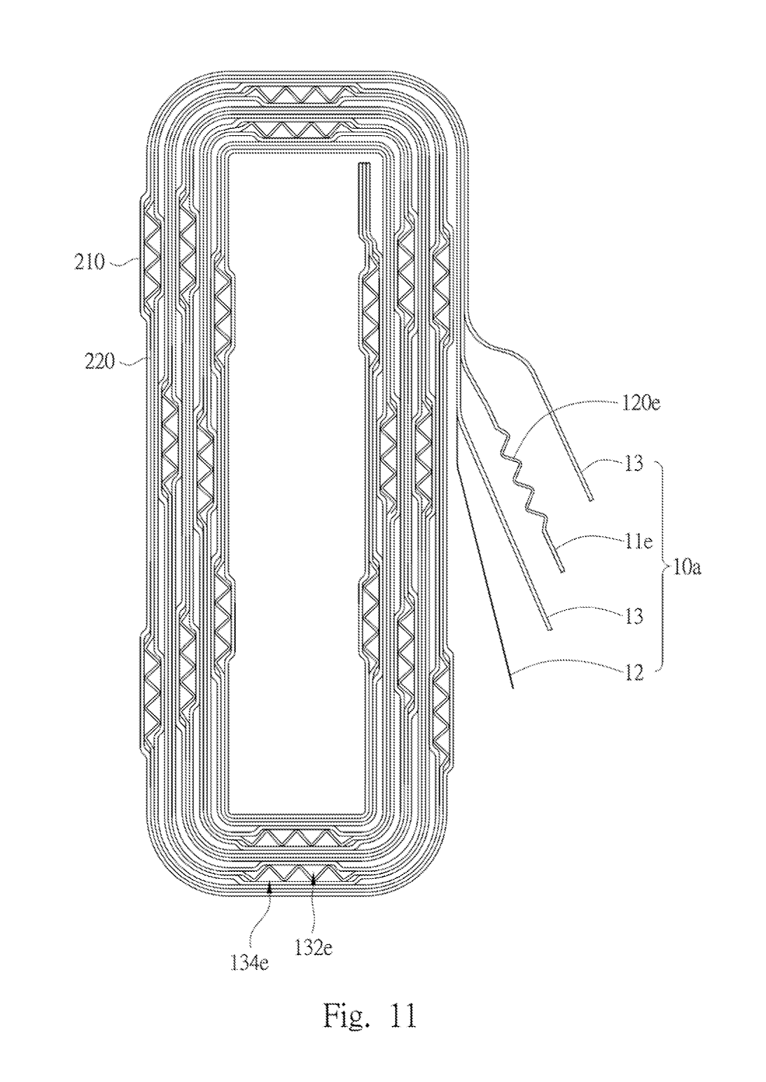

FIG. 11 is a top view of the electromagnetic device in accordance with another embodiment of the present invention. As shown in FIG. 11, the winding 10a includes a conductive structure 11e, an insulation structure 12 and at least one current sharing structure 13. The conductive structure 11e, the insulation structure 12 and the current sharing structure 13 are cooperatively wound as a cylinder, and they are coaxial. The current sharing structure 13 contacts with the conductive structure 11le to prevent from the deformation of the protrusions 120e of the conductive structure 11e. For example, there are two current sharing structures 13, and the conductive structure 11e can be sandwiched between the current sharing structures 13, so as to maybe prevent from the external force exerting to the protrusions 120e, thereby maybe preventing from the deformation of the protrusions 120e.

In some embodiment, the current sharing structure 13 is a conductor. Therefore, when the conductive structure 11e is conducted, the current not only flows through the conductive structure 11e, but also flows through the current sharing structure 13. In other words, the current may flow through plural paths, and therefore, even though the impedance of the conductive structure 11e may increase because the uneven shape of the protrusions 120e, the current may flow through the current sharing structure 13 with lower impedance. As such, the whole impedance of the winding 10a may be lowered.

Moreover, when the conductive structure 11e is conducted, it may be affected by the magnetic field generated from the electromagnetic induction, such that a great portion of the current may flow on the surface of the conductive structure 11e, which may form an uneven distribution of current and increase the impedance. This effect is also called the skin effect. However, because the current sharing structure 13 can transfer the current as well, the current not only flows on the surface of the conductive structure 11e, but also flows through the current sharing structure 13, which may alleviate the affect of the skin effect.

In some embodiments, as shown in FIG. 11, the current sharing structure 13 has a supporting area 210 and a non-supporting area 220. The non-supporting area 220 is adjoined to the supporting area 210. The supporting area 210 contacts with the protrusions 120e of the conductive structure 11e. In this embodiment, the supporting area 210 is flat to resist the external force and to protect the protrusions 120e.

The non-supporting area 220 does not contact with the protrusions 120e. As shown in FIG. 11, the non-supporting area 220 may be flat. In other embodiments, the non-supporting area 220 may be uneven to form additional heat dissipation passages, so as to maybe allow the airflow to flow therethrough, which may improve the heat dissipation ability.

In some embodiments, as shown in FIG. 11, the winding 10e is wound outwardly along the radial direction, so as to form a cylinder.

In this embodiment, the electromagnetic device takes the conductive structure 11e as example, but in other embodiments, the electromagnetic may take the conductive structures 11-11d and 11f to replace the conductive structure 11e.

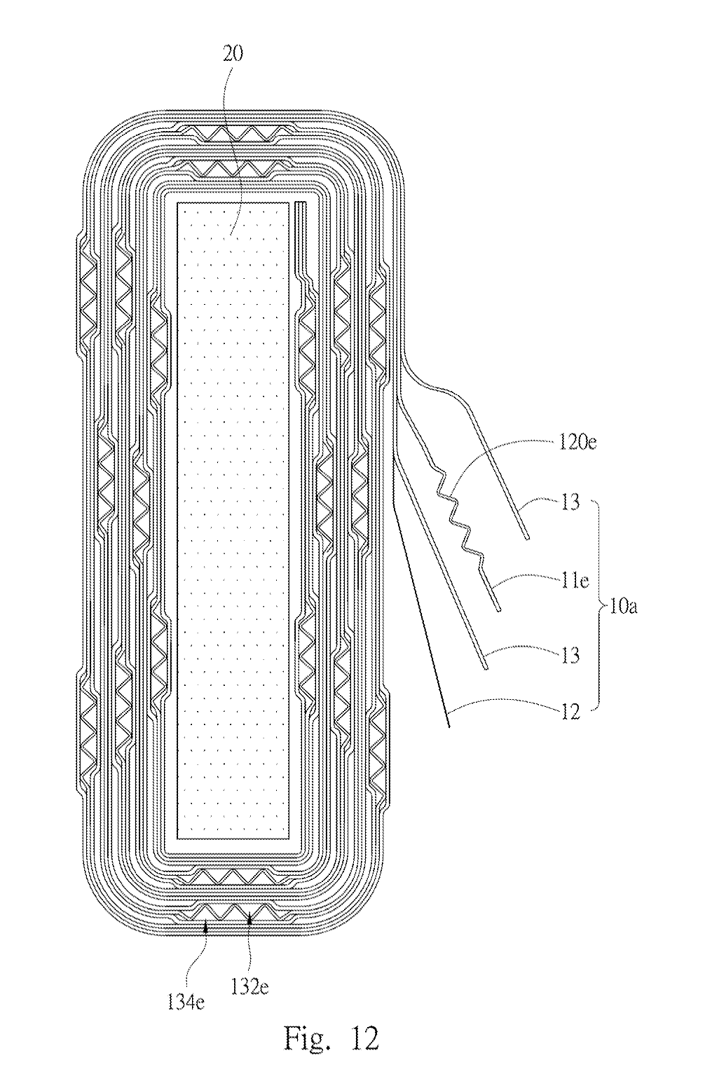

FIG. 12 is a top view of the electromagnetic device in accordance with another embodiment of the present disclosure. The main difference between the electromagnetic device in this embodiment and FIG. 11 is that: the electromagnetic device includes a magnetic core 20. The winding 10a surrounds the magnetic core 20. When the current flows through winding 10a, the generated magnetic field and the magnetic field of the magnetic core 20 may affect each other. The electromagnetic device may be, but are not limited to be, applied in the single phase reactor, the triple phase reactor, the single phase transformer or the triple phase transformer.

FIG. 13 is a perspective view of the electromagnetic device in accordance with another embodiment of the present disclosure. The main difference between the electromagnetic device in this embodiment and FIG. 11 is that: the winding manner of the winding 10b is different from which of the foregoing winding 10a. In particular, the winding 10b is wound along the axial direction from the top side to the bottom side (or vice versa), so as to form a cylinder overlapped from the top side to the bottom side (or vice versa).

The connecting surface 116 of the conductive structure 11g is parallel to the radial direction D2 of the winding 10b. The conductive structure 11g includes a plurality of protrusions 120 and 120e. The first heat dissipation passage 132 defined by adjacent two of the protrusions 120 and the second heat dissipation passage 134 within the protrusion 120 extend along the radial direction D2 of the winding 10b. In particular, the winding 10b is wound as a cylinder, and the radial direction D2 is the direction along the radius of the cylinder. Similarly, the first heat dissipation passage 132e defined by adjacent two of the protrusions 120e and the second heat dissipation passage 134e within the protrusion 120e extend along the radial direction D2 of the winding 10b. In such a configuration, the airflow may flow through the first heat dissipation passages 132 and 132e and the second heat dissipation passages 134 and 134e along the radial direction D2 of the winding 10b, so as to maybe achieve heat dissipation.

In this embodiment, the conductive structure 11g includes the protrusions 120 and 120e, but in other embodiments, the conductive structure 11g may include the protrusion 120a, 120b, 120c, 120d or 120f as well.

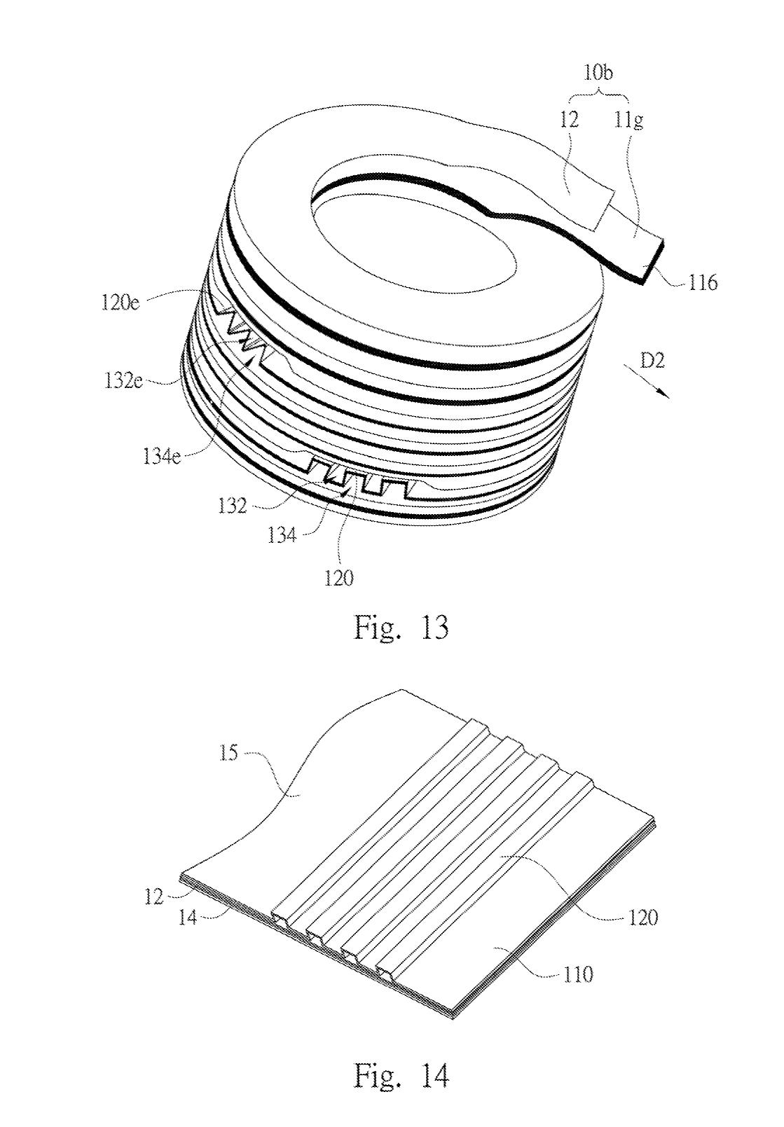

FIG. 14 is a perspective view of the electromagnetic device in accordance with another embodiment of the present disclosure. In this embodiment, as shown in FIG. 14, the electromagnetic device includes an insulation structure 12 and two conductive layers 14 and 15. The insulation structure 12 is sandwiched between the conductive layers 14 and 15, so as to separate the conductive layers 14 and 15. As such, the conductive layers 14 and 15 can be seen as two independent circuits insulated from each other, and therefore, the electromagnetic device can be used as a busbar, which can, but is not limited to, electrically connect to the power device, the capacitor or the battery.

In this embodiment, the conductive layer 15 may be any of the conductive structures 11-11f shown in FIGS. 3-9. For example, the conductive layer 15 includes a plurality of protrusions 120, so as to maybe improve the heat dissipation ability of the electromagnetic device.

In this embodiment, the surface of the conductive layer 14 is flat. In other embodiments, the conductive layer 14 can be any of the conductive structures shown in FIGS. 3-9 that has any of the protrusions 120-120f, so as to maybe improve the heat dissipation ability of the electromagnetic device.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A conductive structure for an electromagnetic device, comprising:
a conductive sheet having two electrical connection terminals; and
a plurality of protrusions, which are arranged between the electrical connection terminals and comprise a support which connects with the conductive sheet, wherein two of the protrusions adjacent to each other define a first heat dissipation passage.

2. The conductive structure of claim 1, wherein the conductive sheet comprises a top long side and a bottom long side, and the top long side and the bottom long side connect with the electrical connection terminals, wherein at least one of the protrusions is a stick that connects the top long side and the bottom long side.

3. The conductive structure of claim 2, wherein the protrusion being the stick is a hollow structure having two openings on opposite ends thereof and has a second heat dissipation passage, and the second heat dissipation passage and the first heat dissipation passage are arranged alternately.

4. The conductive structure of claim 3, wherein the support of the protrusion being the stick has at least one through hole that connects the first heat dissipation passage and the second heat dissipation passage.

5. The conductive structure of claim 2, wherein the support of the protrusion being the stick is flat or uneven.

6. The conductive structure of claim 2, wherein the conductive sheet has a connecting surface, and the protrusions are connected to the connecting surface, and the protrusion being the stick has a cross-sectional pattern defined along a direction perpendicular to the connecting surface, and the cross-sectional pattern is inverted-U shaped, inverted-V shaped, trapezoidal or arc-shaped.

7. The conductive structure of claim 1, wherein the conductive sheet has a widthwise direction and has a top long side and a bottom long side, wherein the top long side and the bottom long side are connected to the electrical connection terminals, and the widthwise direction extends across the top long side and the bottom long side, and at least two of the protrusions are spatially separated from each other along the widthwise direction.

8. The conductive structure of claim 7, wherein at least one of the protrusions which are separated from each other along the widthwise direction is a hollow structure having two openings on opposite ends thereof, and the protrusion being the hollow structure has a second heat dissipation passage, and the second heat dissipation passage and the first heat dissipation passage are arranged alternately.

9. The conductive structure of claim 7, wherein adjacent two of the protrusions which are spatially separated from each other along the widthwise direction are aligned or misaligned along the widthwise direction.

10. The conductive structure of claim 7, wherein at least one of the protrusions which are spatially separated from each other along the widthwise direction has a rectangular cross-sectional pattern, a diamond-shaped cross-sectional pattern, a circular cross-sectional pattern, an elliptic cross-sectional pattern or a triangular cross-sectional pattern.

11. The conductive structure of claim 1, further comprising at least one block, wherein one of the protrusions is a hollow structure, and the block is arranged in the protrusion being the hollow structure.

12. The conductive structure of claim 1, wherein the conductive sheet has a connecting surface, and the protrusions are connected to the connecting surface, wherein the protrusions have at least two different cross-sectional patterns defined along a direction perpendicular to the connecting surface.

13. The conductive structure of claim 1, wherein the protrusions are arranged equidistantly.

14. The conductive structure of claim 1, wherein the protrusions are arranged non-equidistantly.

15. The conductive structure of claim 1, wherein the protrusions are arranged on a partial area of the conductive sheet.

16. The conductive structure of claim 1, wherein the conductive sheet and the protrusions are integrally formed.

17. The conductive structure of claim 1, wherein material of the conductive sheet comprises copper, aluminum, copper alloy or aluminum alloy.

18. An electromagnetic device, comprising:
a winding comprising a conductive structure of claim 1.

19. The electromagnetic device of claim 18, further comprising:
an insulation structure, wherein the conductive structure and the insulation structure are cooperatively wound, and the insulation structure contacts with the conductive structure and is coaxial with the conductive structure.

20. The electromagnetic device of claim 18, further comprising:
a current sharing structure, wherein the conductive structure and the current sharing structure are cooperatively wound, and the current sharing structure contacts with the conductive structure and is coaxial with the conductive structure, wherein the current sharing structure is a conductor.

21. The electromagnetic device of claim 18, further comprising:
a magnetic core surrounded by the winding.

22. An electromagnetic device, comprising:
an insulation structure; and
two conductive layers, wherein the insulation structure is sandwiched between the conductive layers, and at least one of the conductive layers is the conductive structure of claim 1.
